(19) United States
(12) Patent Application Publication
(10) Pub. No.: US 2022/0091443 A1
(43) Pub. Date: Mar. 24, 2022

(54) MODULAR FACE AND EYES MASK/SHIELD

(71) Applicant: Ariel Finkelstein, San Juan, PR (US)

(72) Inventor: Ariel Finkelstein, San Juan, PR (US)

(21) Appl. No.: 17/025,793

(22) Filed: Sep. 18, 2020

(51) Int. Cl. G02C 9/04; G02C 7/16; G02C 7/10; A41D 13/11

(52) U.S. Cl. CPC G02C 9/04; G02C 7/16; A41D 13/1107; A41D 13/1184; G02C 7/108

(57) ABSTRACT

An article of manufacture for providing a wearable modular face and eyes mask or shield is disclosed. The article is made of an eyeglass frame having a pair of temples, a nose bridge, and a pair of nose pads one each of two sides of the nose bridge; a pair of detachable protective shields interchangeably coupled to the eyeglass frame orienting the detachable protective shield on a user in front of the user's face when worn, a first detachable protective shield is a full face shield utilizing one or more screws oriented through the detachable face shield being attached to the each temple, a second detachable protective shield is an eye shield oriented along a front edge of the eyeglass frame and about the pair of nose pads coupled within one or more retaining slots along both sides of the nose bridge running from a top edge of the eyeglass frame to below the nose pads and a retaining slot about a front edge of each temple where the temple meets the nose bridge, the eye shield is inserted into the one or more retaining slots; and a clip in lens holder. The clip-in lens holder includes a pair of eyeglass lens retainers on either side of a lens holder nose bridge, one or more retaining clips along a bottom edge of the lens holder nose bridge for coupling the lens holder nose bridge to the nose bridge above the pair of nose pads; and a pair of eyeglass lens.

### TECHNICAL FIELD

This application relates in general to an article of manufacture for providing a personal protection device, and more specifically, to an article of manufacture for a wearable modular face and eyes mask or shield.

### BACKGROUND

Today, face coverings, ranging from face masks, face shields, eye protectors are widely worn around the world. These coverings are hot, uncomfortable, and often provide little protection from outside contaminants. In fact, most simply contain the wearer's own fluids, while marginally excluding contaminants from the outside. The particular environment in which the face covering is worn may determine the size and nature of the face covering that is needed.

Therefore, a need exists for an article of manufacture for providing a wearable modular face and eyes mask or shield. The device should easily convert from one form of protective device to another while providing a comfortable wearing position. Accommodations for corrective lens may also be included to permit user to utilize prescription lens as necessary to engage in activities requiring use of such a face covering. The present invention attempts to address the shortcomings of existing solutions according to principles of the present invention as disclosed herein.

### SUMMARY

In accordance with the present invention, the above and other problems are solved by providing an article of manufacture for a wearable modular face and eyes mask or shield according to the principles and example embodiments disclosed herein.

In one embodiment, the present invention is an article of manufacture for providing a wearable modular face and eyes mask or shield. disclosed. The article is made of an eyeglass frame having a pair of temples, a nose bridge, and a pair of nose pads one each of two sides of the nose bridge; a pair of detachable protective shields interchangeably coupled to the eyeglass frame orienting the detachable protective shield on a user in front of the user's face when worn, a first detachable protective shield is a full face shield utilizing one or more screws oriented through the detachable face shield being attached to the each temple, a second detachable protective shield is an eye shield oriented along a front edge of the eyeglass frame and about the pair of nose pads coupled within one or more retaining slots along both sides of the nose bridge running from a top edge of the eyeglass frame to below the nose pads and a retaining slot about a front edge of each temple where the temple meets the nose bridge, the eye shield is inserted into the one or more retaining slots; and a clip in lens holder. The clip-in lens holder includes a pair of eyeglass lens retainers on either side of a lens holder nose bridge, one or more retaining clips along a bottom edge of the lens holder nose bridge for coupling the lens holder nose bridge to the nose bridge above the pair of nose pads; and a pair of eyeglass lens.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture for providing a wearable modular face and eyes mask or shield.

FIG. 2 illustrates another example embodiment of an article of manufacture for a wearable modular face and eyes mask or shield according to the present invention.

FIG. 3 illustrates an example embodiment of an article of manufacture for a wearable modular face and eyes mask or shield according to the present invention.

FIG. 4 illustrates another example embodiment of an article of manufacture for a wearable modular face and eyes mask or shield according to the present invention.

FIGS. 5a-b illustrate an example embodiment of an article of manufacture for a wearable modular face and eyes mask or shield as worn by a user according to the present invention.

FIGS. 6a-c illustrate components from an example embodiment of an article of manufacture for a wearable modular face and eyes mask or shield according to the present invention.

FIGS. 7a-f illustrate components from an example embodiment of an article of manufacture for a wearable modular face and eyes mask or shield according to the present invention.

FIG. 8 illustrates an exploded view of components combined to create an article of manufacture for a wearable modular face and eyes mask or shield according to the present invention.

### DETAILED DESCRIPTION

This application relates in general to an article of manufacture for providing a personal protection device, and more specifically, to an article of manufacture for a wearable modular face and eyes mask or shield according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “customer,” and “user” refer to an entity, e.g. a human, using the wearable modular face and eyes mask or shield associated with the invention. The term user herein refers to one or more users.

The term “invention” or “present invention” refers to the invention being applied for via the patent application with the title “Modular Face and Eyes Mask/Shield.” Invention may be used interchangeably with face mask.

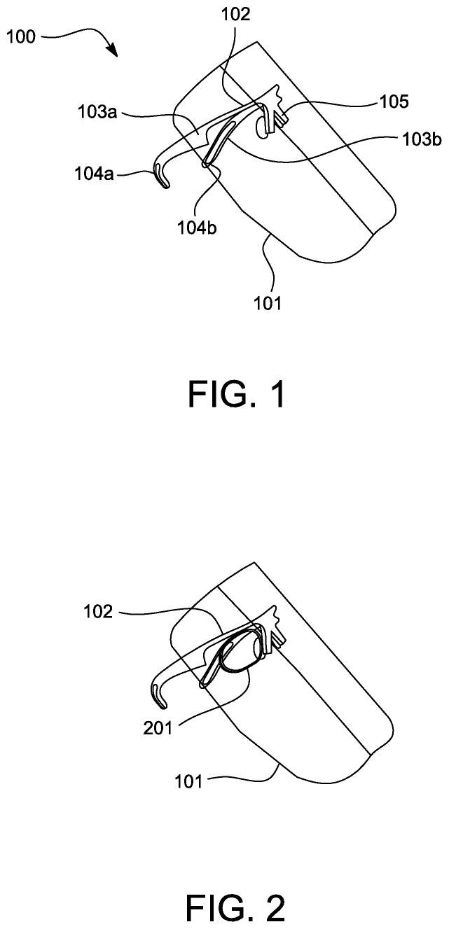

In general, the present disclosure relates to an article of manufacture for providing a personal protection device. To better understand the present invention, FIG. 1 illustrates an example embodiment for an article of manufacture for a wearable modular face shield 100. In this embodiment, a pair of detachable protective shields 101 interchangeably coupled to the eyeglass frame 102 orienting the detachable protective shield on a user in front of a user's face when worn is coupled to an eyeglass frame 102 to provide complete face shield cover/protection to a user. The eyeglass frame 102 has frame temples 103 a-b having ear supports 104a-b and a pair of nose pads 104. The eyeglass frame 102 does not contain a frame element for holding lenses.

The wearable modular face shield 100 is adaptable to a user's face shape while having no pressure points and remaining non-slip. The wearable modular face shield 100 may be made of hypoallergenic material that contains no metal, latex, and silicone resulting in a light, flexible and stable wearable modular face shield 100 that is pleasantly fixed and balanced to wear. The use of hypoallergenic material also results in a device that causes no skin and eye irritation.

The pair of detachable protective shields 101 comprises a first detachable protective shield that is a full face shield utilizing one or more screws oriented through the detachable face shield being attached to the each temple. The pair of detachable protective shields 101 further comprises a second detachable protective shield is an eye shield oriented along a front edge of the eyeglass frame and about the pair of nose pads coupled within one or more retaining slots along both sides of the nose bridge running from a top edge of the eyeglass frame to below the nose pads and a retaining slot about a front edge of each temple where the temple meets the nose bridge, the eye shield is inserted into the one or more retaining slots.

The components of the wearable modular face shield 100 may be snapped together using stable click-connections that are easy to change. In a preferred embodiment, the components of the wearable modular face shield 100 may be constructed without the use of screws, although embodiments that attach the shield 101 to the eyeglass frame 102 may utilize screws as well.

The eyeglass frame 102 is comfortable and adapts to an individual's head shape. It is completed with a face or eye shield 101 and can be supplemented with regular optical lenses by a clip-in mechanism as shown in FIG. 2. Any configuration of the presented embodiments can be easily put on and taken off by a user. The wearable modular face shield 100 provides protection during communication and social events or while dealing with patients. The eye-shield accessory meets the requirements for personal protective equipment and it can be used in any industry, analytical laboratories or other environments where eye protection is required.

FIG. 2 illustrates another example embodiment of an article of manufacture for a wearable modular face shield according to the present invention. The wearable modular face shield 100 is shown having a complete face shield cover/protection and regular prescription eyeglasses. The eyeglass frame 102 may be supplemented with regular optical lenses by a clip-in lens holder 201 that may hold prescription lenses, sunglass lenses, UV-blocking lenses, and any similar type of lenses typically included in eyeglasses. The clip-in lens holder 201 includes a pair of eyeglass lens retainers on either side of a lens holder nose bridge, one or more retaining clips along a bottom edge of the lens holder nose bridge for coupling the lens holder nose bridge to the nose bridge above the pair of nose pads; and a pair of eyeglass lens. In all other respects, the embodiment of FIG. 2 is similar to the one shown in FIG. 1.

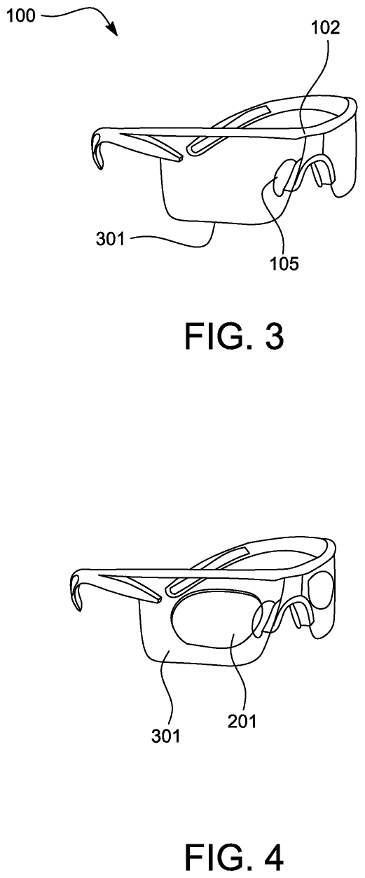

FIG. 3 illustrates an example embodiment of an article of manufacture for providing a wearable modular face and eye shield according to the present invention. In this embodiment, the wearable modular face shield 100 is shown having the eyeglass frame 102 as disclosed above with the face shield 101 replaced by an eye shield 301 that is coupled to the eyeglass frame 102 in the same manner as used with the face shield 101 as shown in FIGS. 1-2. FIG. 4 illustrates another example of the wearable modular face/eye shield 100 utilizing the eye shield 301 and eyeglass lens frames 102 having the clip-in mechanism 201 according to the present invention.

The eyeglass frames 102 of the wearable modular face/eye shields 100 provide a flexible, robust and ultra-light article that's comfortable to wear. The modular design of the wearable modular face/eye shield 100 provides an individual multi-fit of the device to the user including a customizable nose pad. The eyeglass frames 102 may be made in many colors to appeal to a user who may be required to wear the article for significant portions of a day while working or engaging in hazardous activities. As noted above, sunglasses or any prescription lenses may be used as shown in FIG. 4 using an attachment (clip-in) mechanism.

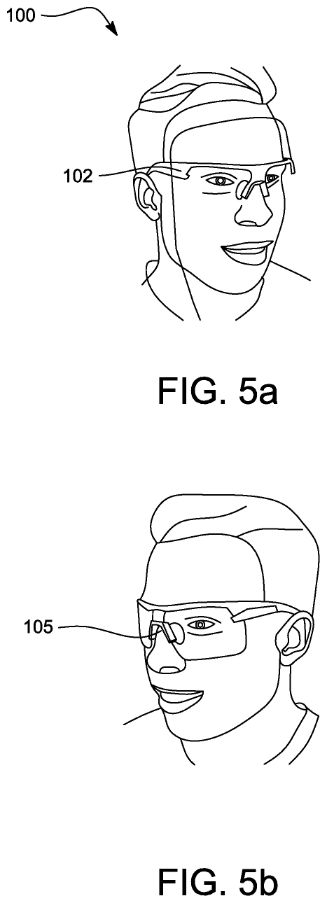

FIGS. 5a-b illustrate an example embodiment of an article of manufacture for providing a wearable modular face and eye mask or shield as worn by a user according to the present invention. As user is shown wearing an embodiment of the eyeglass frames 102 in FIGS. 5a-b. The custom frame 102 has a special adapter to adjust the nose pads 104 to fit a particular nose size and to provide additional padding to the user. A smaller children's model also may be made with an elastic strap (not shown) to provide more stability while being worn.

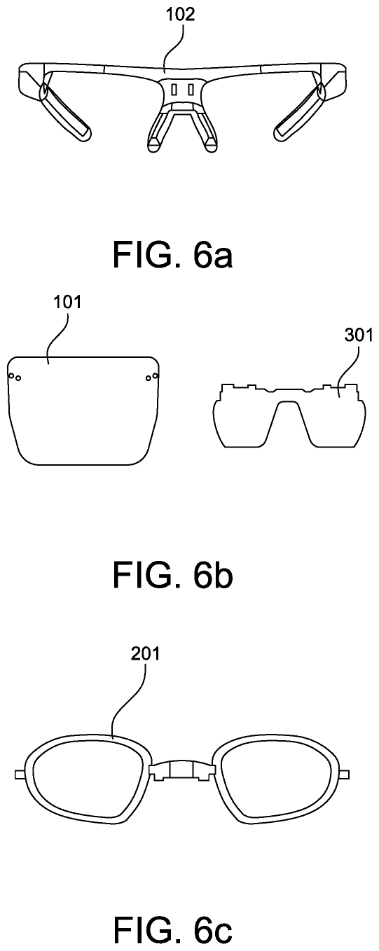

FIGS. 6a-c illustrate components from an example embodiment of an article of manufacture for a wearable modular face and eye mask or shield according to the present invention. FIG. 6a shows the eyeglass frame 102. FIG. 6b shows the face shield 101 and the eye shield 301. FIG. 6c shows the clip-in lens holding mechanism 201.

The face shield 101 is made from a transparent, scratch-resistant, and reusable plastic material. The face shield 101 does not yellow and does not reflect light. The face shield may be fixed and removed with 4 pins or screws on the carrier. Many of these components, especially the face shield 101 and eye shield 301, also may be provided separately as refills.

The eye-shield 301 is also made from transparent and scratch-resistant plastic. The eye shield 301 also does not yellow or reflect light, and may be easily clicked into and out of the carrier. The clip-in lens holding mechanism 201 is arranged to be clicked easily into or out of the eyeglass frame 102 providing optically glazed lenses as needed for an individual user. New prescriptions of different lenses may be used by a user in different environments as needed.

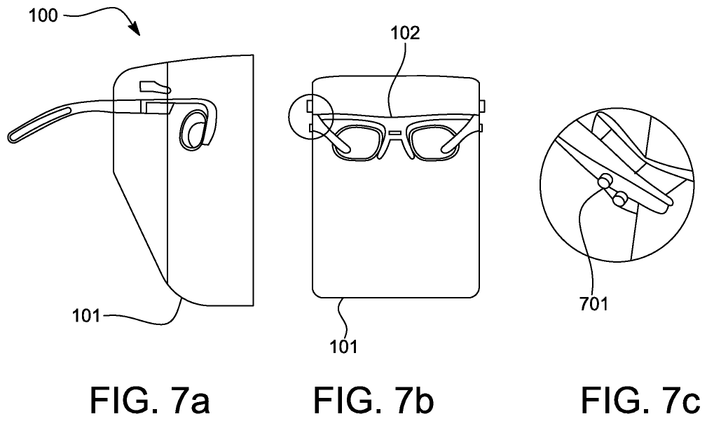

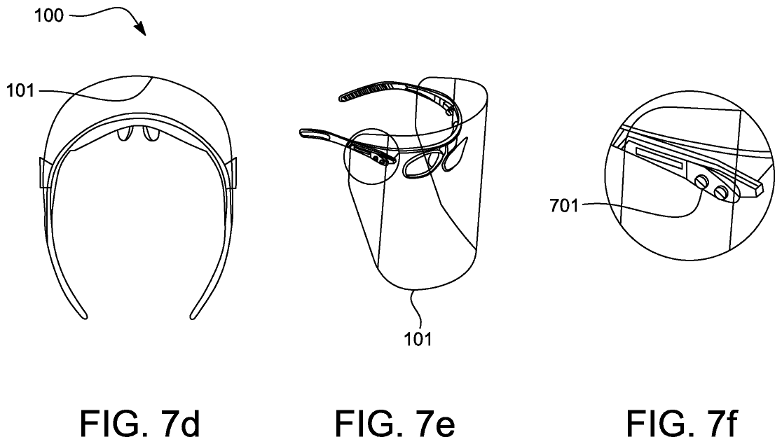

FIGS. 7a-f illustrate components from an example embodiment of an article of manufacture for a wearable modular face and eyes shield according to the present invention. FIG. 7a shows a side profile view of the wearable modular face and eyes shield 100 including the face shield 101. FIG. 7b shows a frontal view of the wearable modular face and eyes shield 100 including the face shield 101 highlighting a connection point 701 between the face shield 101 and the eyeglass frame 102 about the eyeglass frame temples 103a-b. FIG. 7c shows a close up view of the connection point 701 which may consist of snap-on devices as well as screw in devices to retain the face shield 101 to the eyeglass frame 102.

FIG. 7d shows a top down view of the wearable modular face and eyes shield 100 including the face shield 101. FIG. 7e shows a perspective view of the wearable modular face and eyes shield 100 including the face shield 101 also highlighting a connection point 701 between the face shield 101 and the eyeglass frame 102 about the eyeglass frame temples 103a-b. FIG. 7f also shows a close up view of the connection point 701 which may consist of snap-on devices as well as screw in devices to retain the face shield 101 to the eyeglass frame 102.

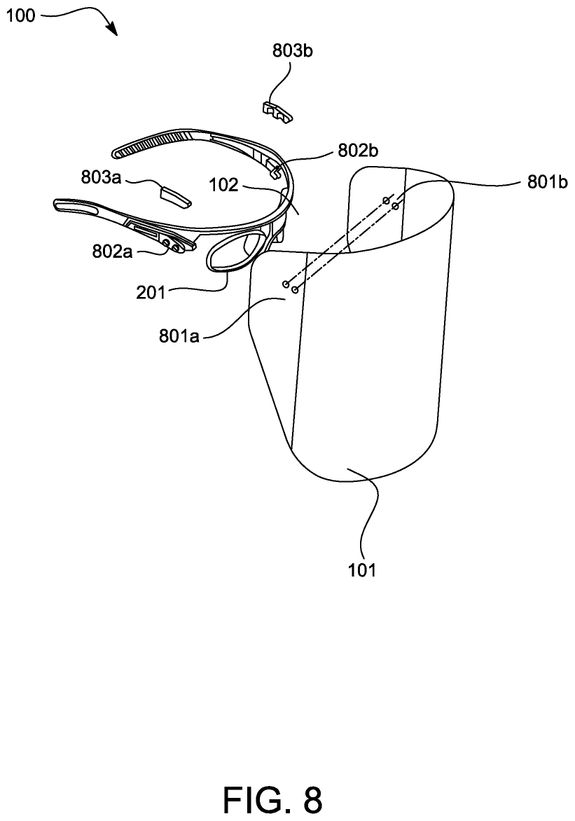

FIG. 8 illustrates an exploded view of components combined to create an article of manufacture for a wearable modular face and eyes shield 100 according to the present invention. The wearable modular face and eyes shield 100 comprises the face shield 101 with two sets of attachment holes 801a-b, the eyeglass frame 102 including the clip-in lens holding mechanism 201, a pair of attachment points 802a-b for coupling the face shield 101 to the eyeglass frame 102 and a pair of covers 803a-b for protecting the attachment points 802a-b once the face shield 101 is attached to the eyeglass frame 102.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for a wearable modular face and eyes mask and shield, the article comprises:
an eyeglass frame having a pair of temples, a nose bridge, and a pair of nose pads one each of two sides of the nose bridge;
a detachable protective shield coupled to the eyeglass frame orienting the detachable protective shield on a user in front of the user's face when worn; and
a one or more coupling devices for holding the detachable protective shield on each side of the detachable protective shield attached to the eyeglass frame.

2. The article according to claim 1, wherein
the detachable protective shield is a full face shield; and
the one or more coupling devices are one or more pins oriented through the detachable face shield being attached to the each temple.

3. The article according to claim 1, wherein
the detachable protective shield is an eye shield, the eye shield oriented along a front edge of the eyeglass frame and about the pair of nose pads; and
the one or more coupling devices are one or more retaining slots along both sides of the nose bridge running from a top edge of the eyeglass frame to below the nose pads and a retaining slot about a front edge of each temple where the temple meets the nose bridge, the eye shield is inserted into the one or more retaining slots.

4. The article according to claim 2, wherein article further comprises a clip in lens holder, the clip-in lens holder comprises:
a pair of eyeglass lens retainers on either side of a lens holder nose bridge;
one or more retaining clips along a bottom edge of the lens holder nose bridge for coupling the lens holder nose bridge to the nose bridge above the pair of nose pads; and
a pair of eyeglass lens.

5. The article according to claim 4, wherein the pair of eyeglass lens having a visual correcting prescription associated with the user.

6. The article according to claim 4, wherein the pair of eyeglass lens having a color tint for reducing luminosity and glare for the user.

7. The article according to claim 5, wherein the pair of eyeglass lens having a color tint for reducing luminosity and glare for the user.

8. An article of manufacture for a wearable modular face and eyes mask and shield, the article comprises:
an eyeglass frame having a pair of temples, a nose bridge, and a pair of nose pads one each of two sides of the nose bridge;
a pair of detachable protective shields interchangeably coupled to the eyeglass frame orienting the detachable protective shield on a user in front of the user's face when worn, the pair of detachable protective shields comprising a first detachable protective shield is a full face shield utilizing one or more pins oriented through the detachable face shield being attached to the each temple and a second detachable protective shield is an eye shield oriented along a front edge of the eyeglass frame and about the pair of nose pads coupled within one or more retaining slots along both sides of the nose bridge running from a top edge of the eyeglass frame to below the nose pads and a retaining slot about a front edge of each temple where the temple meets the nose bridge, the eye shield is inserted into the one or more retaining slots; and
a clip in lens holder, the clip-in lens holder comprises:
a pair of eyeglass lens retainers on either side of a lens holder nose bridge;
one or more retaining clips along a bottom edge of the lens holder nose bridge for coupling the lens holder nose bridge to the nose bridge above the pair of nose pads; and
a pair of eyeglass lens.

9. The article according to claim 8, wherein the pair of eyeglass lens having a visual correcting prescription associated with the user.

10. The article according to claim 8, wherein the pair of eyeglass lens having a color tint for reducing luminosity and glare for the user.
